(19) United States
(12) Patent Application Publication
(10) Pub. No.: US 2020/0229556 A1
(43) Pub. Date: Jul. 23, 2020

(54) WALKING AID FOR SHOES, SHOE SYSTEM COMPRISING A SHOE AND A WALKING AID, AND SYSTEM CONSISTING OF A WALKING AID AND A STICK

(71) Applicant: LMJ COMMERCE GMBH, Amsberg (DE)

(72) Inventor: Marcus MAAßEN, Köln (DE)

(21) Appl. No.: 16/633,383

(22) PCT Filed: Jul. 24, 2018
(86) PCT No.: PCT/DE2018/100665

§ 371 Date: Jan. 23, 2020

(30) Foreign Application Priority Data
Jul. 26, 2017 (DE) 10 2017 116 922.9

(51) Int. Cl. A45B 9/04; A61H 3/00

(52) U.S. Cl. CPC A45B 9/04; A61H 3/00; A61H 2205/12; A61H 2201/165; A61H 2201/1253

(57) ABSTRACT

A walking aid (01, 02), in particular for shoes having a solid sole, a shoe system, and a system including the walking aid (01, 02) and a stick (18, 19), such as a walking stick or a ski stick. In exemplary embodiments, walking aid (01, 02) includes a main body (02.1, 0.2) for detachable arrangement on a sole and at least one fastening means (03.1, 03.2, 03) detachably fastened to the shoe, and, when fastened to the shoe, the main body (02.1, 02) extends from the toe of the shoe up to 40% of a length of the sole.

### TECHNICAL FIELD

The present disclosure relates to a walking aid, in particular for shoes with a fixed sole, wherein the walking aid has a main body for detachable arrangement on the sole and has at least one fastening means for detachable fastening to a shoe. The present disclosure furthermore relates to a shoe system having a shoe, in particular with a fixed sole, and having a walking aid for detachable fastening to the shoe. The present disclosure also relates to a system comprising a walking aid and a stick.

### BACKGROUND

For various activities and different requirements, it is expedient to use special shoes. In the case of said special shoes, characteristics may arise which, although on the one hand are desired for the respective activity or requirement, may however be disadvantageous when the shoe is used outside the respective activity or outside the respective situation that generates the requirement.

For example, the shoes may have a fixed or rigid sole. Such shoes are for example however used by no means exclusively for Alpine sport, in particular for skiing. The shoes are optimized for the respective use, that is to say for combination with a ski binding and a ski, but are afflicted with corresponding disadvantages when used without a ski and ski binding.

The present invention will be described below primarily with reference to shoes with a fixed sole, such as are used for example for skiing. The subjects of the present invention are however by no means restricted or limited to such shoes or to use with such shoes. The description rather serves for illustrating and clarifying the invention in the context of ski shoes.

For said shoes, in particular for shoes with a fixed sole, there has always been the problem that walking is made difficult in such shoes. Furthermore, depending on the design of the shoe, it may also be the case that an unnatural body posture, in particular an unnatural posture of the legs, is caused when standing in the shoes. The latter is the case for example with ski shoes, in the case of which the movement of the ankle joint and thus the relative orientation between foot and lower leg is restricted. Furthermore, in particular shoes with a fixed sole have the disadvantage that walking on stairs, or performing similar movements, is possible only with difficulty and with in some cases greatly increased risk of falling.

These disadvantages have in the past led to the development of walking aids which are in some cases provided for detachable fastening to a shoe. Here, the previous approaches to a solution have normally solved one of the above-stated problem, whereas other problems have remained or even been exacerbated. For example, the device of the disclosure of U.S. Pat. No. 4,045,890 B is suitable for facilitating roll-off with a shoe with a fixed sole and thereby making walking easier, but on the other hand, the device disclosed in said document makes the use of stairs considerably more difficult and even increases the risk of an injury when using a staircase.

The device disclosed in US 2011/0258882 A1 duly permits the safe use of stairs and improves the roll-off characteristics, but does not lead to the unnatural posture of the legs or of the ankle joint when standing being improved or corrected. Similar devices which each solve a part of the above-stated problems are known from the following documents: US 2012/0117829 A1, DE 20 2006 002 533 U1, DE 199 59 353 A1, U.S. Pat. Nos. 4,774,775 B, 4,461,104 B, DE 25 41 638 A1, DE 26 55 564 A1, DE 26 49 296 A1 and DE 2 314 847 A1.

### SUMMARY

Against this background, it is the object of the present invention to overcome the disadvantages of the devices from the prior art. In particular, it is the object of the present invention to propose a walking aid, a shoe system and a system composed of a walking aid and of a stick, which each permit an improvement in comfort and safety.

Said object is achieved in the case of a walking aid of the type mentioned in the introduction in that the main body is designed such that, when fastened on the shoe, said main body extends from a shoe tip only up to 40% of a sole length of the sole.

It has surprisingly been found that, in the case of a main body which extends from the tip of the sole up to 40% of the sole length, roll-off and thus walking are made easier, standing is improved, and the safety when using stairs and similar obstacles is at least not adversely affected. Furthermore, the design of the main body with a length which extends from the shoe tip up to at most 40% of the sole length leads to an extremely compact walking aid. This has the advantage that the walking aid according to the invention, which is designed to be only temporarily arranged on a shoe and accordingly detachable, can be carried or stowed in a particularly space-saving manner, in particular when the walking aid is not arranged on the shoe.

In a first advantageous refinement, provision may be made whereby, when the walking aid is fastened to the shoe, the main body extends from the shoe tip up to at most a length of 35% of the sole length. In this way, the walking aid can be made even more compact without this having an influence on the advantageous effect on walking and standing, the safety when using stairs, and the like, with a shoe equipped with the walking aid.

Provision may very particularly preferably be made whereby the walking aid, in particular the length of the main body of the walking aid, is designed in a manner adapted to the shoe interior. This is because the sole length is an extremely important measure for the dimensioning of the main body. In particular in order to achieve optimum walking characteristics, it is however also of importance where and how the foot of a user of a shoe is arranged in the shoe and relative to the sole. Accordingly, in a further particularly preferred embodiment of the invention, provision is made whereby the main body is designed so as to extend as far as a position of the sole over which the metatarsophalangeal joint of a foot situated in the shoe is arranged. Since the metatarsophalangeal joint forms the definitive point during the roll-off of the foot when walking without restriction by a shoe it is possible, by means of the extent of the main body from the shoe tip as far as a position of the sole over which the metatarsophalangeal joint of a foot situated in the shoe is situated, to realize a particularly effective and natural roll-off. Here, provision may particularly preferably be made whereby the main body is designed such that the lever point of the main body that arises owing to the walking aid during roll-off is arranged slightly behind the joint center of the metatarsophalangeal joint of a foot correspondingly situated in the shoe.

The walking aid is particularly preferably equally suitable for being arranged on a right shoe and on a left shoe. For this purpose, provision may for example be made whereby the walking aid is of symmetrical design with respect to a longitudinal axis of the walking aid. This facilitates the arrangement of the walking aid or of the walking aids on a shoe or on a pair of shoes, because there is no need for one walking aid to be assigned to in each case one shoe, but rather each walking aid can be arranged on either shoe.

A further embodiment of the walking aid provides for the main body to have a ground contact face and to be of wedge-shaped design such that, when fastened to the shoe, a greater distance between the sole and the ground contact face is generated with increasing distance from the shoe tip. By means of the wedge shape of the main body, the position of the legs, in particular the position of the lower legs when standing, in a corresponding shoe can be influenced. This is advantageous in particular this the use of the shoe is associated with a limitation of the mobility of the ankle joint, which inhibits or restricts the orientation between foot and lower leg. Also, particularly uniform roll-off can be achieved by means of the wedge-shaped design of the main body.

In a further, particularly preferred embodiment, provision may be made whereby the main body has recesses and webs on the upper face averted from the ground contact face. In this way, it can firstly be achieved that the walking aid can still be fastened or arranged relatively securely on the shoe even in the case of material being adhered to the sole of the shoe. Furthermore, through the formation of webs and recesses on the upper face, which is averted from the ground contact face, of the main body, the weight of the walking aid can be reduced. Further advantages that can be achieved by means of the respective design of the webs and recesses will be described in more detail with the following embodiments of the walking aid according to the invention.

In a preferred refinement, provision may be made whereby the webs and recesses form a first and a second contact profile on the upper face, which is averted from the ground contact face, of the main body. Accordingly, the present invention also relates to a pair of walking aids which have the design according to the invention of the main body and which furthermore have recesses and webs in the upper face averted from the ground contact face, which recesses and webs form a first and a second contact profile in each walking aid. It is thus made possible for two walking aids to correspondingly be arranged relative to one another such that, in each case, the webs of a first contact profile engage into the recesses of a second contact profile and vice versa. In this way, the packing size of the walking aids, in particular the packing size of a walking aid pair, is particularly advantageously reduced when the walking aids are not arranged on the shoe but rather are detached from the shoe.

Furthermore, in a further particularly advantageous embodiment, provision may be made whereby the first contact profile is of complementary design with respect to the second contact profile. This is because, by means of the contact profiles of complementary design with respect to one another, the main bodies of the walking aids can be at least partially placed in engagement with one another, whereby the height of a pair of walking aids that are at least partially in engagement with one another is considerably smaller than the height of two individual walking aids. The webs and recesses and/or the resulting at least partial engagement are in this case configured and/or dimensioned such that the engagement can be produced and eliminated again manually and, in the event of engagement, a clamping action between the walking aids is generated by means of the webs and recesses, such that an undesired release or separation of the walking aids is prevented.

A further particularly advantageous embodiment of the walking aids provides for the main body to comprise a front body part and a rear body part. In the context of this embodiment, it is pointed out that the extent according to the invention of the main body from the shoe tip up to a part of the sole length is in relation to the total length of the main body, which in the present embodiment is formed by the front and the rear body parts. The design of the walking aid with a front and a rear body part has various advantages. For example, the front body part and the rear body part may be manufactured from different materials, wherein the material selection is made such that a secure arrangement or fastening of the walking aid to the shoe is ensured, and at the same time a simple and secure arrangement of the walking aid on the shoe and a secure and simple detachment of the walking aid from the shoe are made possible. Further advantages of an embodiment of the main body with a front body part and a rear body part will be discussed below with reference to further embodiments.

For example, provision may advantageously be made whereby the front body part and the rear body part can be pivoted into a pivoted-out configuration and into a pivoted-together configuration. In this way, it is advantageously possible for the packing size of an individual walking aid in a state detached from the shoe to be reduced. For this purpose, provision may be made whereby the front body part and the rear body part transferred into the pivoted-out configuration for the arrangement of the walking aid on the shoe, and are transferred into the pivoted-together configuration, and assume a space-saving outer dimension or packing size in the pivoted-together configuration, when the walking aids are being transported before or after a period of being arranged on the shoe.

A further particularly advantageous embodiment provides for the body parts to have recesses and webs on the upper face averted from the ground contact face. In this case, too, the recesses and webs of the body parts, that is to say of the front body part and of the rear body part of the main body, may serve for enabling the walking aid to be securely arranged on the shoe even if there is still material adhered to the sole. Furthermore, through the formation of recesses in the upper face, which is averted from the ground contact face, of the body parts, the weight of the walking aid can be advantageously reduced.

In a further, particularly preferred embodiment, provision may furthermore be made whereby, in particular in the front body part, the recesses extent at least partially as far as the ground contact face. This firstly has the advantage that a particularly great reduction in weight of the walking aid can be achieved by means of the recesses which extend as far as the ground contact face. Furthermore, the recesses, which extend through as far as the ground contact face, in the body part, in particular in the front body part, may serve as a profile or profiling of the ground contact face, and thus increase safety both when standing and when walking with a shoe and with a walking aid according to the invention arranged thereon.

Likewise, in a further embodiment of the walking aid with a front and a rear body part of the main body, provision may be made whereby the recesses and webs in the front body part and in the rear body part are of complementary design with respect to one another such that, in a pivoted-together configuration of the body parts, the recesses and webs are placed in engagement with one another at least in certain portions. In this way, the extent or the packing size of the walking aid in the pivoted-together configuration can be considerably reduced. This is because, then, the webs of the front body part engage at least partially, or at least in certain portions, into corresponding recesses in the rear body part and vice versa, and thus reduce the packing size in the pivoted-together configuration in relation to an embodiment without complementary profiling of the upper faces situated opposite the ground contact faces.

The walking aid according to the invention should in particular assume a particularly compact form when it is not arranged on the shoe in order to be able to be carried in the most effective and space-saving manner possible. For this purpose, a further, advantageous embodiment provides for the front body part and the rear body part to be connected to one another by means of a double joint. Through the use of a double joint, a particularly space-saving transport position, for example in the form of the pivoted-together configuration of the two body parts, can be achieved.

In a further, particularly preferred embodiment of the walking aid, provision may be made whereby at least one fastening means is designed as an elastic fastening means, in particular as a tension strap. In this way, an easy and secure arrangement and an easy and reliable release of the walking aid on the shoe or from the shoe can be achieved. The elastic fastening means may particularly preferably serve for fastening the walking aid in the heel region of the shoe.

In a further, particularly preferred embodiment, provision may furthermore be made whereby the elastic fastening means is designed so as to permit both the fastening of the walking aid to the shoe and the securing of the walking aid in a pivoted-together configuration. Such an embodiment has numerous advantages. Firstly, through the use of the elastic fastening means for securing the walking aid in the pivoted-together configuration, it is ensured that the walking aid remains in the pivoted-together configuration until the elastic fastening means is released and thus the pivoted-together configuration, or the remaining in the pivoted-together configuration, is eliminated. Secondly, through the twofold use of the elastic fastening means for fastening the walking aid to the shoe, on the one hand, and for securing the walking aid in the pivoted-together configuration, on the other hand, a further reduction of the packing size of the walking aid in the pivoted-together configuration is achieved, because the elastic fastening means is substantially prevented from protruding from the walking aid in the pivoted-together configuration.

A further, particularly advantageous embodiment of the walking aid provides for the ground contact face to have a profile and to have at least one profile recess which is designed for at least partially receiving a stick, in particular a ski stick or walking stick. The corresponding recess on a surface of the walking aid can particularly advantageously be utilized for fastening the walking aid to a stick when said walking aid is not arranged on the shoe but rather has been detached from the shoe. The transport of the walking aid when it has been released from the shoe is thus made easier. At the same time, the profile recess, as part of the profile of the ground contact face, may also realize a profile function of a sole profile when the walking aid is arranged on a shoe, and thus improve the safety for the user of the walking aid when the latter is arranged on a shoe.

A particularly preferred embodiment of the walking aid provides for the elastic fastening means, when securing the walking aid in the pivoted-together configuration, to surround the walking aid at least over a full periphery in particular on an outer contour formed at least partially by the ground contact face. In this way, particularly effective securing of the walking aid in the pivoted-together configuration can be achieved. Furthermore, in this way, the elastic fastening means can be particularly advantageously arranged or tensioned on the outer circumference or on the outer contour of the walking aid in the pivoted-together configuration, such that the elastic fastening means does not protrude from the walking aid and thus take up additional space.

Furthermore, in a preferred refinement of the walking aid, provision may be made whereby the elastic fastening means is designed such that, in particular when the walking aid is secured by the fastening means in the pivoted-together configuration, the receiving of a stick, in particular of a ski stick or walking stick, in and/or on the profile recess is secured. This embodiment of the fastening means thus relates, like the securing in the pivoted-together configuration by the fastening means as already described above, to a respective second or further use of the fastening means in addition to the detachable fastening of the walking aid to a shoe. This manifold applicability of the fastening means leads to particularly advantageous usability of the walking aid both when it is arranged on a shoe and before or after it is arranged on a shoe.

In the case of a shoe system having a shoe, in particular with a fixed sole, and having a walking aid for detachable fastening to the shoe, the object stated in the introduction is achieved in that the walking aid is designed in accordance with one of the above-described embodiments.

In this way, the advantages already described with reference to the individual embodiments of the walking aid can also be realized for the shoe system. Here, advantageous effects can be generated not only when the walking aid is arranged on the shoe. Owing to the compact embodiment, further advantages of the above-described embodiments of the walking aid can also be realized when the walking aid is not arranged on the shoe.

A particularly preferred embodiment of the shoe system provides for a fixed sole to have a sole profile at least in certain portions, and for an upper face, averted from the ground contact face of the walking aid, to have a contact profile, wherein the sole profile and the contact profile are at least partially of complementary design with respect to one another. The complementary design of the contact profile and of the sole profile should be provided in particular in the region in which the walking aid comes to bear against the shoe, in particular against the sole of the shoe, when the walking aid is arranged or being arranged on the shoe. Owing to the complementary design of the contact profile and of the sole profile with respect to one another, a particularly secure arrangement of the walking aid on the shoe can be achieved. The contact profile of the walking aid may be formed by means of the webs and recesses, already described above, of the main body or of the body parts of the main body.

For the sake of completeness, it is pointed out at this juncture that the contact profile described above does not need to be the same type of profile as described above with regard to the first and second contact profiles. The present contact profile is arranged at least inter alia on the upper face, averted from the ground contact face, of the walking aid, and interacts with a sole profile of a shoe. The above-described contact profile is formed at least inter alia on the ground contact face and serves primarily for the detachable connection or coupling of in each case two walking aids to one another. It is thus clear that both types of contact profiles each facilitate or impart contact with respect to another object, but the other object with which the contact is produced may take different forms, and thus the arrangement of the contact profile on the walking aid may also differ.

The above-stated object is achieved, in the case of a system composed of a walking aid and of a stick, in particular a ski stick or walking stick, by means of a coupling device for detachably fastening the walking aid to the stick.

The walking aid and the coupling device may particularly preferably have complementary coupling elements. The coupling elements are advantageously designed such that a detachable coupling between the coupling device and the walking aid can be realized.

Provision may advantageously furthermore be made whereby the coupling device can be fastened to the stick.

The corresponding system composed of walking aid and stick makes it possible, in particular by means of the complementary coupling elements, for the walking aid to be securely fastened to the stick and quickly and reliably detached from the stick in order to be mounted or arranged on a shoe.

The coupling devices may also be formed by the stick itself.

In an advantageous refinement, provision may be made whereby the walking aid has the above-described features and thus realizes the corresponding advantages.

### BRIEF DESCRIPTION OF THE DRAWINGS

Further advantages and details of the invention will be discussed below on the basis of the exemplary embodiments illustrated in the drawings, in which:

FIG. 1 shows an exploded drawing of a walking aid according to the invention according to a first embodiment;

FIG. 2 shows a side view of a walking aid according to the invention according to the first embodiment;

FIGS. 3a-3c show a transfer of a walking aid according to the invention according to a second embodiment from a pivoted-out configuration into a pivoted-together configuration;

FIG. 4 shows a plan view of a walking aid according to a first embodiment;

FIG. 5 shows a rear view of a walking aid according to the invention according to the first embodiment;

FIG. 6 shows a bottom view of a walking aid according to the invention according to a first embodiment;

FIG. 7 shows an exploded drawing of a system according to the invention according to a first embodiment; and

FIG. 8 shows a system according to the invention according to a first embodiment.

### DETAILED DESCRIPTION

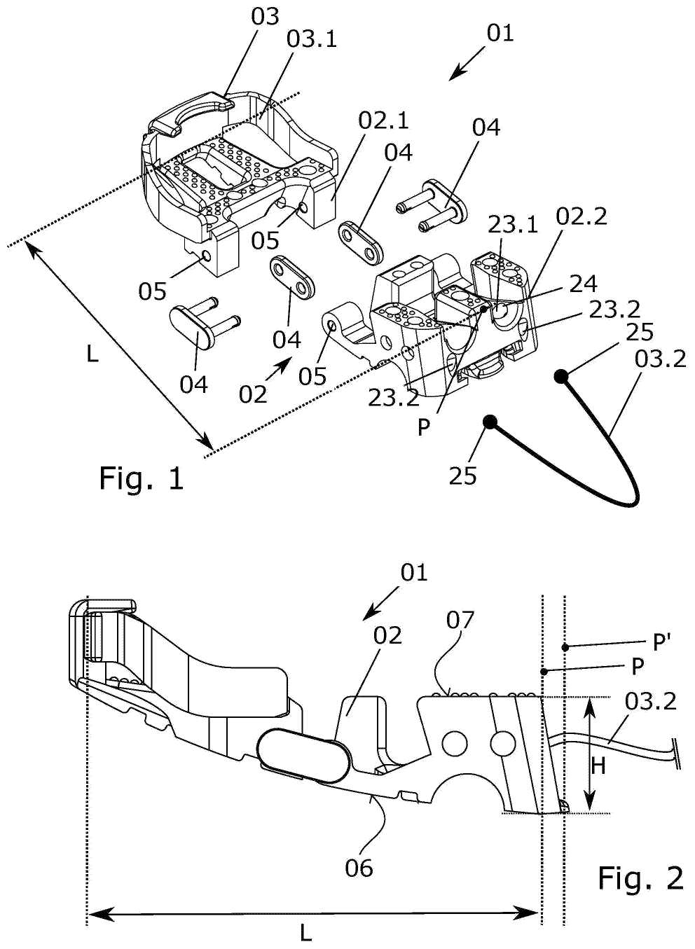

FIG. 1 shows a walking aid 01 according to the invention, in the case of which the main body 02 has a front body part 02.1 and a rear body part 02.2. The walking aid 01 furthermore comprises two fastening means 03. One of the fastening means 03 is designed as an elastic fastening means 03.2 in the form of a tension strap, which is fastened to the rear body part 02.2. The second fastening means 03 is arranged on the front body part 02.1 and is realized by a rigid fastening means 03.1.

Using the fastening means 03, the walking aid 01 can be detachably arranged on a sole of a shoe, in particular on a rigid sole of a shoe. For this purpose, the shoe tip is placed in engagement with the first fastening means 03.1. Accordingly, the fastening means 03.1 is also designed similarly to a corresponding shoe tip receptacle of a ski binding. The second fastening means 03 in the form of the elastic fastening means 03.2 is tensioned around the heel of the shoe. In this way, a force is generated which holds the walking aid 01 securely on the sole of the shoe for as long as the fastening means 03.2 is fitted around the heel of the shoe. In the case of a ski shoe, the heel protrusion of the shoe, which otherwise engages into the heel part of the ski binding, secures the elastic fastening means and thus the walking aid on the shoe.

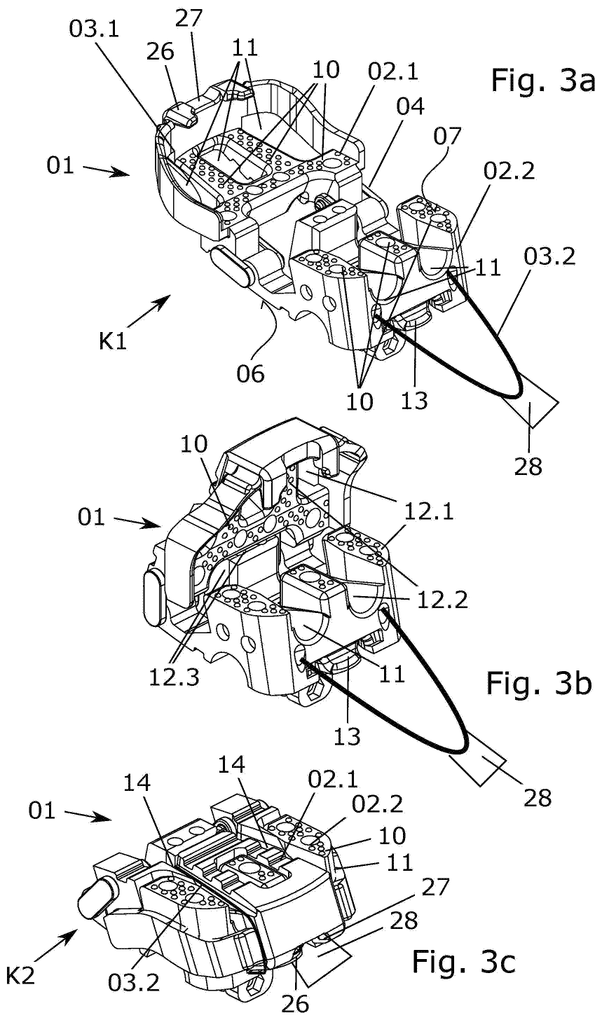

The body parts 02.1 and 02.2 of the main body 02 are connected to one another by means of two double joints 04 which engage into corresponding bearing points 05 in the body parts 02.1, 02.2. The front body part 02.1 may have an upper part 02.3 and a lower part 02.4, which are composed of different materials. The material selection may be made such that, for the upper part 02.3, optimum hold between shoe and walking aid 01 can be realized, and, for the lower part 02.4, optimum grip on different underlying surfaces can be achieved. The upper part 02.3 and the lower part 02.4 may for example be adhesively bonded to one another or connected to one another in some other way. By means of the double joints 04, it is made possible for the front body part 02.1 and the rear body part 02.2 to be pivoted from a pivoted-out configuration into a pivoted-together configuration. The corresponding transfer between the two configurations of the body parts will be discussed in more detail with reference to FIGS. 3a to 3c.

According to the present invention, the main body 02 has a total length L which extends from the shoe tip up to at most 40% of the length of a sole of a shoe on which the walking aid is arranged. The total length L of the main body 02 particularly preferably extends from a shoe tip up to at most 35% of the sole length of the shoe. The length L is of course the length of the walking aid 01 in an installed state and not the length in the state of the exploded drawing of FIG. 1.

Accordingly, in one embodiment of the invention, provision may be made whereby the total length of the main body has a length of 115 mm in the case of a sole length of 335 mm, and the main body extends from the shoe tip over the front 115 mm of the shoe sole when the walking aid is arranged on a shoe.

By means of this dimensioning of the length of the main body, measured from the shoe tip or the sole tip, it can be achieved that the main body extends as far as a position P of the sole of the shoe over which the metatarsophalangeal joint of a foot situated in the shoe is arranged. In this way, it is possible in particular for roll-off to be considerably improved in the case of assistance from the walking aid according to the invention.

The rear body part 02.2 furthermore has two channels 24 which each form two channel openings 23.1, 23.2. By means of the channels 24, the second fastening means 03.2 can be fastened to the main body, in particular to the rear body part. For this purpose, the second fastening means may for example have end portions 25 with an enlarged diameter, wherein the diameter of the end portions 25 is greater than the diameter of the relatively small channel openings 23.2 and smaller than the diameter of the relatively large channel openings 23.1 of the channel 24. Thus, the end portions 25 are at least partially received by, and secured in, the channels 24.

The weight of a walking aid according to the invention preferably amounts to less than 120 g, particularly preferably less than 100 g. The walking aid thus has not only a small packing size but also a low weight.

Further embodiments relating to the dimensioning and design of the main body 02 of the walking aid 01 will be described below with reference also to FIG. 2.

In the side view of FIG. 2, it can be seen that the main body 02 forms, with its ground contact face 06 and the upper face 07 averted from the ground contact face 06, a wedge shape which, when the walking aid 01 has been fastened to a shoe (not illustrated in FIG. 2), has the effect that a greater distance between the sole (not illustrated in FIG. 2) and the ground contact face 06 is generated with increasing distance from the shoe tip. Roll-off is facilitated by means of the wedge-shaped design of the main body 02.

By means of the maximum height H of the wedge-shaped main body 02, it is furthermore possible to set or vary the position of the shoe when standing, and, in the case of a restriction of the movement of the ankle joint by the shoe, thus also the entire posture when standing in a corresponding shoe. This means that, by means of the maximum height H of the main body 02, the walking aid 01 can improve safety and comfort when standing. It can also be seen from FIG. 2 that the main body 02, proceeding from a shoe tip or tip of a shoe sole, runs as far as a position P of the sole (not illustrated) over which the metatarsophalangeal joint of a foot situated in the shoe is arranged. For this purpose, the main body extends from the shoe tip or tip of the shoe sole over at most 40%, particularly preferably over at most 35%, of the sole length of the shoe.

In the illustration of FIG. 2, it can furthermore be seen that the main body extends on the ground contact face as far as a position P′ which is situated slightly behind the position of the sole over which the metatarsophalangeal joint of a foot situated in the shoe is arranged. It is thereby made possible for the lever point 08 that must be overcome by means of the walking aid 01 during roll-off to be arranged slightly behind the joint center of the metatarsophalangeal joint of a foot situated in the shoe. Roll-off and walking with the aid of the walking aid are thus further improved.

With reference to FIGS. 3a to 3c, inter alia the function of the double joints 04 in conjunction with the front body part 02.1 and the rear body part 02.2 and the design of the body parts 02.1 and 02.2 will be discussed. FIG. 3a shows the walking aid 01 in a pivoted-out configuration K1. The pivoted-out configuration K1 constitutes the configuration in which the walking aid 01 can be arranged on a shoe or fastened to a shoe. It can be clearly seen from the illustration of FIG. 3a that both the front body part 02.1 and the rear body part 02.2 each have webs 10 and recesses 11 arranged between the webs. In the case of the front body part 02.1, provision is furthermore made whereby at least a part of the recesses 11 extend from the upper face 07, which is averted from the ground contact face 06, as far as the ground contact face 06, which firstly improves the profiling of the ground contact face 06 and secondly advantageously reduces the weight of the walking aid 01.

In the exemplary illustration of FIG. 3a, it can already be seen that the webs 10 and recesses 11, arranged on the upper face 07, averted from the ground contact face 06, of the front body part 02.1 and of the rear body parts 02.2 are, at least in certain portions, of complementary design with respect to one another, such that, in a pivoted-together configuration as illustrated in FIG. 3c, the respective webs 10 of the rear body part 02.2 are at least partially placed in engagement with one another with corresponding recesses 11 of the front body part 02.1. The same of course also applies conversely to the webs 10 of the front body part 02.1 and the recesses 11 of the rear body part 02.2. Corresponding recess-web pairs 12.1, 12.2 and 12.3 are highlighted by way of example in the illustration of FIG. 3b.

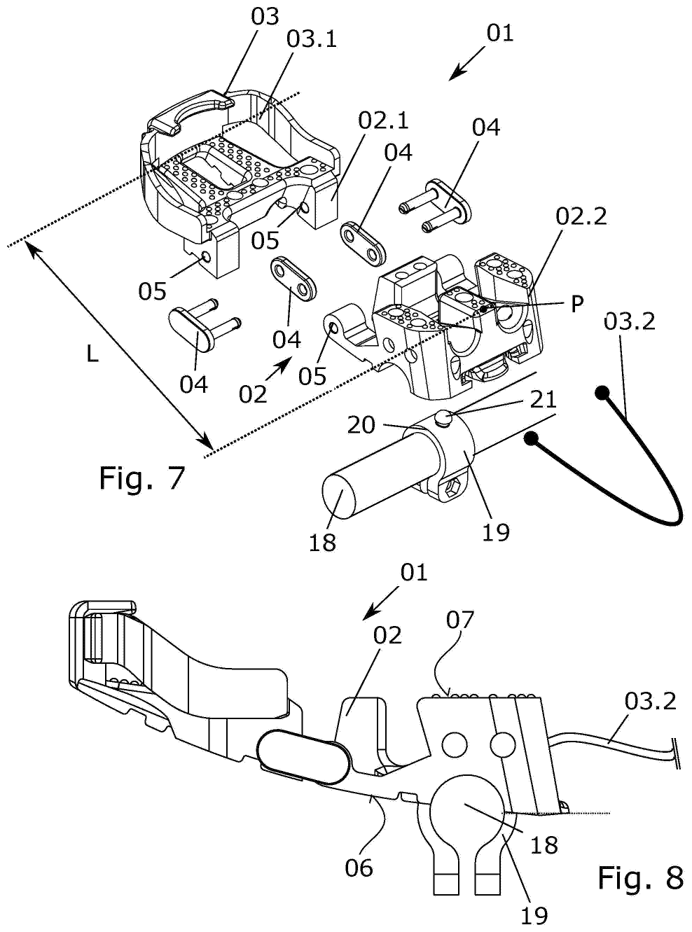

Likewise particularly clearly visible in FIGS. 3a and 3b is a securing means 13 which, in interaction with the elastic fastening means 03.2, secures the securing of the walking aid in the pivoted-together configuration K2 illustrated in FIG. 3c. For this purpose, the elastic fastening means 03.2 is, in the pivoted-together configuration K2 illustrated in FIG. 3c, led from the rear body part 02.2 around the front body part 02.1, wherein the ground contact face 06 of the front body part 02.1 has corresponding guide recesses 14 for this purpose. The guide recesses 14 may simultaneously serve as a profile of the ground contact face 06. The elastic fastening means is subsequently laid around the rear body part 02.2, for which purpose the rear body part in FIG. 3c may also have guide recesses 14 (not visible) (see FIG. 7). Subsequently, the elastic fastening means 03.2 is led around the securing means 13.

Here, the length of the elastic fastening means 03.2, and the elastic characteristics thereof, are configured such that, when surrounding the walking aid 01 in the pivoted-together position K2, as shown in the illustration of FIG. 3c, on the outer contour of the pivoted-together walking aid 01, the elastic fastening means is stretched, that is to say undergoes an elastic deformation. It is thereby ensured that, by means of an additional or further elastic deformation of the elastic fastening means 03.2, the fastening means 03.2 is released from the securing means 13 and the securing of the walking aid 01 in the pivoted-together configuration K2 can be eliminated by the elastic fastening means 03.2. Equally, it can be ensured by means of the elastic deformation that the elastic fastening means 03.2, when secured on the securing means 13, secures the walking aid 01 in the pivoted-together configuration K2.

It can furthermore be seen from FIGS. 3a to 3c that the rigid fastening means 03.1 comprises a projecting length 26 which is for example placed in contact with an upper side of a projection of a ski shoe in order to fasten or arrange the walking aid 01 on the ski shoe. Furthermore, the elastic fastening means 03.2 is equipped with a grip element 28. The grip element serves for the manual actuation, in particular for manual elastic stretching, of the elastic fastening means 03.2. The grip element may be formed from textile material and be connected to the fastening means 03.2. In order to realize a particularly compact form or particularly compact packing size in the pivoted-together configuration K2 of the walking aid 01, provision may be made for the projecting length 26 of the rigid fastening means 03.1 to have an aperture 27 arranged on an upper side of the projecting length, in which aperture, in the pivoted-together configuration K2 of the walking aid 01, the grip element 28 of the elastic fastening means 03.2 is at least partially received, as indicated by way of example in FIG. 3c. The aperture 27 thus makes it possible for the grip element 28 to bear closely against the walking aid 01, and at the same time be easily accessible, when the elastic fastening means 03.2 is arranged on the securing means 13 for the purposes of securing the walking aid 01 in the pivoted-together configuration K2.

As shown in FIG. 3c, the grip element 28 is in this case preferably designed such that, when partially received in the aperture 27 in the pivoted-together configuration K2 of the walking aid 01, said grip element protrudes beyond the front body part 02.1 and in particular beyond the rigid fastening means 03.1. Thus, the grip element 28 can be easily actuated when the elastic fastening means 03.2 is arranged on the securing means 13. Thus, even in the pivoted-together configuration K2, the grip element 28 is easily accessible in order to eliminate the securing of the walking aid 01 in the pivoted-together configuration K2.

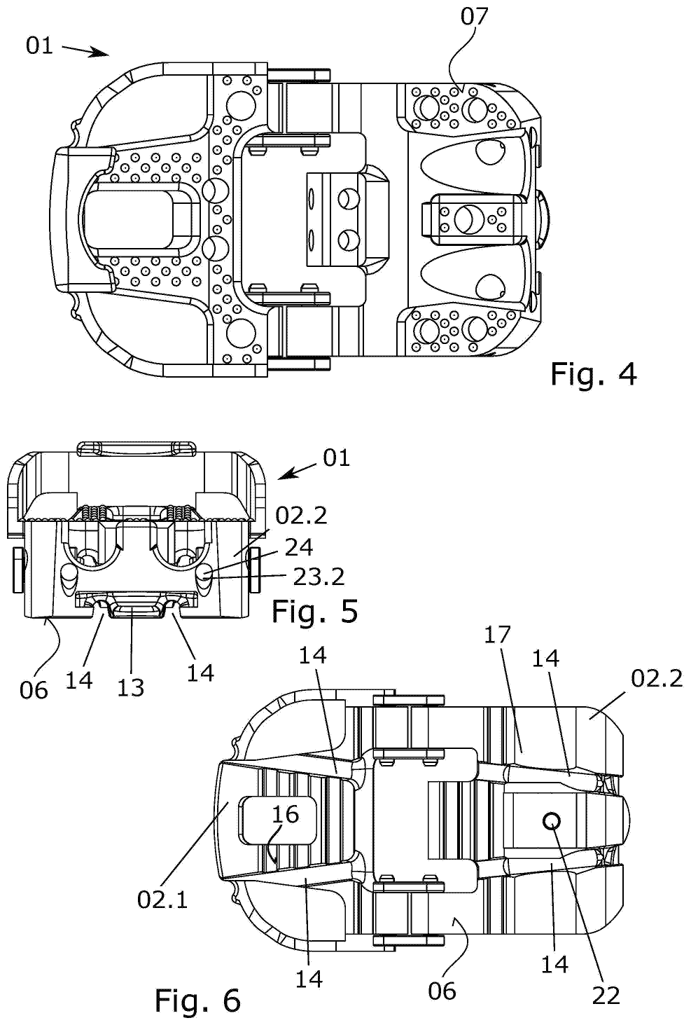

The plan view of FIG. 4 illustrates the upper face 07 averted from the ground contact face 06. For the sake of clarity, FIG. 4, and also FIGS. 5 and 6, illustrate the walking aid according to the invention without the second fastening means. As can be seen from FIG. 4, the upper face 07 comprises a stud structure 15. The stud structure 15 serves for preventing slippage of the walking aid 01 in relation to a shoe (not illustrated in FIG. 4). As an alternative or in addition to the stud structure 15, the upper face 07 may however also form a contact profile which is designed so as to be of complementary form with respect to a sole profile of the shoe on which the walking aid 01 is detachably arranged. This has the particular advantage that, in combination with a shoe which has a corresponding sole profile, particularly good hold of the walking aid when arranged on the shoe can be achieved. By means of a corresponding design of a contact profile and of a sole profile, it is possible to particularly advantageously realize a shoe system in the case of which the walking aid is precisely tailored to the shoe. Furthermore, a particularly advantageous transmission of force between shoe and walking aid can be realized through the realization of complementary sole profiles and contact profiles on the shoe and on the walking aid.

FIG. 5 once again shows, in the rear view of the walking aid 01, the securing means 13 and the guide recesses 14 formed on the ground contact face 06 of the rear body part 02.2, which guide recesses make it possible for the elastic fastening means, which for the sake of clarity is not illustrated in FIG. 5, to serve, when looped around the outer contour of the walking aid in a pivoted-together configuration, for securing the walking aid in the pivoted-together configuration. Here, the guide recesses facilitate the guidance of the elastic fastening means along the ground contact face 06. FIG. 5 furthermore shows the channel openings 23.2 of the channels 24, in which the second fastening means (not illustrated in FIG. 5) can be guided and secured.

The illustration of FIG. 6 illustrates a walking aid 01 in a view of the ground contact face 06. Here, the ground contact face 06 has not only the guide recesses 14 in the front body part 02.1 and in the rear body part 02.2 but also a profile 16. Here, the profile 16 comprises a profile recess 17 which is configured for at least partially receiving a stick, in particular a ski stick or walking stick. In the embodiment of FIG. 6, the profile recess 17 runs substantially perpendicular to the longitudinal direction of the main body. The profile recess 17 preferably has a shape of a circular segment (see FIG. 2) and is accordingly shaped as a cylinder segment. The profile recess 17 may basically also be formed on some other surface of the walking aid 01. However, the formation on the ground contact face 06, that is to say the formation as part of a profile 16 of the ground contact face 06, yields the advantage that the profile recess 17 simultaneously serves as a profile of the walking aid 01 when the walking aid 01 is arranged on a shoe, and thus for increasing safety when standing and walking using a walking aid 01, and the profile recess 17 can be utilized to receive a part of a stick, whereby the fastening of the walking aid to a stick, in particular in the pivoted-together configuration K2 of the walking aid 01, as illustrated in FIG. 3c, is facilitated.

In the case of the walking aid being arranged on a stick, in particular in the pivoted-together configuration K2, not only the profile recess 17 but also the elastic fastening means 03.2 can be used in a particularly advantageous manner, because, as already described with reference to FIG. 3c, in the pivoted-together configuration K2 of the walking aid 01, the elastic fastening means 03.2 can surround the walking aid 01 over a full periphery, preferably along the guide recesses 14 on the outer contour of the walking aid 01, that is to say on the ground contact face 06 of the walking aid 01, in order to secure the walking aid 01 in the pivoted-together configuration K2. In this embodiment, the elastic fastening means may however simultaneously also serve for the securing or fastening of the walking aid 01 to a stick, because a corresponding stick is pressed by the elastic fastening means 03.2 into the profile recess 17 and held there. It is furthermore advantageously realized in this way that, when the elastic fastening means 03.2 is removed from the securing means 13, not only is the securing of the walking aid 01 in the pivoted-together configuration eliminated, but at the same time the securing or fastening of the walking aid 01 on the stick is eliminated or released.

FIG. 7 shows a system according to the invention composed of a walking aid 01, which, similarly to the illustration of FIG. 1, is illustrated in an exploded drawing, and of a stick 18, only a portion of which is illustrated in the illustration of FIG. 7. Aside from the stick 18 and the walking aid 01, the system comprises a coupling device 19 for the purposes of detachably fastening the walking aid 01 to the stick 18. The coupling device 19 comprises a clamp 20 which can be fastened to the stick 18 by a fastening means (not illustrated in FIG. 7) for example in the form of a screw. The coupling device 19 furthermore comprises a coupling element 21 which can be detachably connected to a complementary coupling element 22 of the walking aid. For example, FIG. 7 shows, in the region of the profile recess 17, a coupling element 22 complementary to the coupling element 21 of the coupling device 19. In FIG. 7, the coupling element 21 is designed for example as a ball head, which interacts with the coupling element 22 of the walking aid 01 in accordance with the principle of a press-stud connection.

FIG. 8 likewise shows a system composed of a walking aid 01, of a stick 18 and of a coupling device 19, wherein the walking aid 01 is illustrated still in the pivoted-out configuration K2 in the example of FIG. 8. For secure and space-saving transport, provision may be made whereby the system illustrated in FIG. 8 is also transferred into the pivoted-together configuration K2 for the purposes of transportation of the walking aid 01 when it is not on a shoe.

### REFERENCE DESIGNATIONS

01 Walking aid
02 Main body
02.1 Front body part
02.2 Rear body part
02.3 Upper part
02.4 Lower part
03 Fastening means
03.1 Rigid fastening means
03.2 Elastic fastening means
04 Double joints
05 Bearing point
06 Ground contact face
07 Upper face
08 Lever point
10 Webs
11 Recess
12.1, 12.2, 12.3 Recess-web pairs
13 Securing means
14 Guide recesses
15 Stud structure
16 Profile
17 Profile recess
18 Stick
19 Coupling device
20 Clamp
21, 22 Coupling element
23.1, 23.2 Channel opening
24 Channel
25 End portion
26 Projecting length
27 Aperture
28 Grip element
L Overall length
P, P′ Position
H Height
K1, K2 Configuration

1. A walking aid for shoes with a fixed sole, the walking aid comprising:
a main body for detachable arrangement on the sole and having at least one fastening means for detachable fastening of the walking aid to the shoe, whereby when fastened on the shoe, the main body extends from a tip of the shoe only up to 40% of a length of the sole; and
the main body includes a front body part and a rear body part, whereby the front body part and the rear body part pivot to a pivoted-out configuration and to a pivoted-together configuration.

2. The walking aid as claimed in claim 1, wherein the main body extends up to 35% of the length of the sole.

3. The walking aid as claimed in claim 1, wherein the main body extends as far as a position of the sole over which a metatarsophalangeal joint of a foot in the shoe is located.

4. The walking aid as claimed in claim 1, wherein the main body has a ground contact face and is of wedge-shaped design such that, when fastened to the shoe, a distance between the sole and the ground contact face increases from the tip of the foot rearwardly.

5. The walking aid as claimed in claim 4, wherein the main body has recesses and webs on an upper face averted from the ground contact face.

6. The walking aid as claimed in claim 5, wherein the webs and recesses form a first contact profile and a second contact profile.

7. The walking aid as claimed in claim 6, wherein the first contact profile is of complementary design with respect to the second contact profile.

8. The walking aid as claimed in claim 5, wherein the body parts have recesses and webs on the upper face.

9.-10. (canceled)

11. The walking aid as claimed in claim 8, wherein in the front body part, the recesses extend at least partially as far as the ground contact face.

12. The walking aid as claimed in claim 8, wherein the recesses and webs of the body parts are of complementary design with respect to one another such that, in the pivoted-together configuration, the recesses and the webs are at least partially in engagement with one another.

13. The walking aid as claimed in claim 1, wherein the front body part and the rear body part are connected to one another by at least one double joint.

14. The walking aid as claimed in claim 1, wherein the at least one fastening means includes an elastic fastening means in the form of a tension strap.

15. The walking aid as claimed in claim 14, wherein the elastic fastening means permits both fastening the walking aid to the shoe and the securing the walking aid in the pivoted-together configuration.

16. The walking aid as claimed in claim 4, wherein the ground contact face has a profile and has at least one profile recess that at least partially receives a ski stick or a walking stick.

17. The walking aid as claimed in claim 14, wherein the elastic fastening means, when securing the walking aid in the pivoted-together configuration, surrounds the walking aid at least over a full periphery on an outer contour.

18. The walking aid as claimed in claim 17, wherein the elastic fastening means, when securing the walking aid in the pivoted-together configuration, secures the receiving of a a ski stick or a walking stick, in and/or on the profile recess.

19. A shoe system having a shoe with a fixed sole and having a walking aid for detachable fastening to the shoe, wherein the walking aid is as claimed in claim 1.

20. The shoe system as claimed in claim 19, wherein the fixed sole has a sole profile at least in certain portions, and an upper face, averted from a ground contact face of the walking aid, having a contact profile, wherein the sole profile and the contact profile are at least partially of complementary design with respect to one another.

21. A system comprising:
a walking aid;
a stick selected from ski stick and a walking stick; and
a coupling device for detachably fastening the walking aid to the stick; and
wherein the walking aid is the walking aid of claim 1.

22. (canceled)
